(19) United States
(12) Patent Application Publication
(10) Pub. No.: US 2012/0102561 A1
(43) Pub. Date: Apr. 26, 2012

(54) TOKEN-BASED RESERVATIONS FOR SCSI ARCHITECTURES

(75) Inventor: Kevin D. Butt, Tucson, AZ (US)

(73) Assignee: INTERNATIONAL BUSINESS MACHINES CORPORATION, Armonk, NY (US)

(21) Appl. No.: 12/912,695

(22) Filed: Oct. 26, 2010

(51) Int. Cl. H04L 9/32

(52) U.S. Cl. 726/9

(57) ABSTRACT

A method for enabling reservations in SCSI architectures is disclosed herein. In one embodiment, such a method includes receiving a reservation request from a SCSI initiator. The method then generates a token in response to receiving the reservation request, stores the token, and transmits a copy of the token to the SCSI initiator. The SCSI initiator may attach this token to commands transmitted while the reservation is in place. Upon receiving a command from the SCSI initiator, the method compares the token attached to the command with the stored token. If the attached token and stored token match, the method processes the command. Otherwise, the command is not processed. A corresponding system and computer program product are also described herein.

### BACKGROUND

1. Field of the Invention

This invention relates to systems and methods for enabling reservations in SCSI architectures.

2. Background of the Invention

In storage networks such as storage-area-networks (SANs), storage devices are often shared by multiple servers, multiple applications on the same server, or a distributed application on multiple servers. This sharing of storage devices can make it a challenge to maintain data integrity on the storage devices. To maintain data integrity, access to a storage device needs to be controlled to ensure that data accessed by an application is protected during that access from corruption or modification by another application. SCSI architectures attempt to provide such protection using a feature called “reservations” (including persistent reservations). Reservations are created between SCSI initiator ports and SCSI target ports to ensure exclusive access to storage resources when multiple servers are accessing the same resources.

Unfortunately, SCSI reservations fail to adequately protect data accessed by one application on a server from another application on the same server. This is at least partly because SCSI architectures do not provide protection for individual applications, but rather for “application clients.” Such application clients may encompass multiple applications running on a server. When a reservation is created, an application client is tied to an “I_T nexus,” which corresponds to a relationship between a single port on an initiator device and a single port on a target device. Reservations in SCSI are limited to a single I_T nexus or a group of I_T nexuses, where the group of I_T nexuses can be joined by any I_T nexus. That is, SCSI reservations are limited to a single I_T nexus, which is protected from other I_T nexuses, or a group of I_T nexuses that can be joined by any other I_T nexus (some consider this to provide no real protection). These limitations have led to data integrity problems caused by multiple applications communicating through the same I_T nexus and interfering with one another. These limitations have also led to distributed applications not using SCSI reservations at all because it is too difficult to coordinate through which I_T nexus each access will be made.

In view of the foregoing, what are needed are systems and methods to provide more effective reservations in SCSI architectures. More specifically, systems and methods are needed to ensure that data accessed by one application is protected during that access from corruption or modification by another application.

### SUMMARY

The invention has been developed in response to the present state of the art and, in particular, in response to the problems and needs in the art that have not yet been fully solved by currently available systems and methods. Accordingly, the invention has been developed to provide systems and methods for providing more effective reservations in SCSI architectures. The features and advantages of the invention will become more fully apparent from the following description and appended claims, or may be learned by practice of the invention as set forth hereinafter.

Consistent with the foregoing, a method for enabling reservations in SCSI architectures is disclosed herein. In one embodiment, such a method includes receiving a reservation request from a SCSI initiator. The method then generates a token in response to receiving the reservation request, stores the token, and transmits a copy of the token to the SCSI initiator. An application on a SCSI initiator may attach this token to commands transmitted while the reservation is in place. Upon receiving a command from the SCSI initiator, the method compares the token attached to the command with the stored token. If the attached token and stored token match, the method processes the command. Otherwise, the command is not processed. As will be explained in more detail hereafter, this method protects data accessed by a first application from modification or corruption by other applications, including applications residing on the same server as the first application.

A corresponding system and computer program product are also described and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment where a system and method in accordance with the invention may be implemented;

FIG. 2 is a high-level block diagram showing communication between a SCSI initiator device and a SCSI target device;

FIG. 3 is a high-level block diagram showing various modules for implementing a token-based reservation scheme in a SCSI architecture;

FIG. 4 is a flow diagram showing communication between a SCSI initiator and a SCSI target when using a token-based reservation scheme in accordance with the invention;

FIG. 5 is a flow diagram showing communication that may occur between a SCSI initiator and a SCSI target when a token is not valid; and

FIG. 6 is a flow diagram showing communication between a SCSI initiator and a SCSI target for a command that is not subject to reservations.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

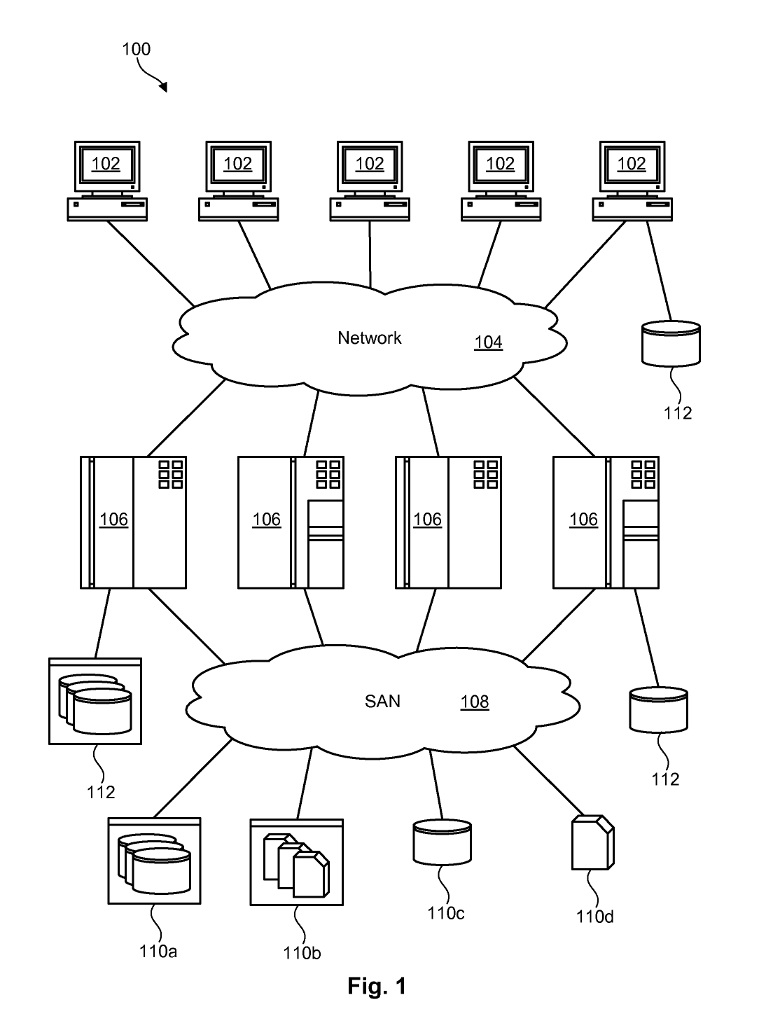

Referring to FIG. 1, one example of a network architecture 100 is illustrated. The network architecture 100 is presented to show one example of an environment where a system and method in accordance with the invention may be implemented. The network architecture 100 is presented only by way of example and is not intended to be limiting. Indeed, the systems and methods disclosed herein may be applicable to a wide variety of different network architectures in addition to the network architecture 100 shown.

As shown, the network architecture 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to as “host systems” 106). In general, the client computers 102 initiate communication sessions, whereas the server computers 106 wait for requests from the client computers 102. In certain embodiments, the computers 102 and/or servers 106 may connect to one or more internal or external direct-attached storage systems 112 (e.g., hard-disk drives, solid-state drives, tape drives, etc.). These computers 102, 106 and direct-attached storage systems 112 may communicate using protocols such as ATA, SATA, SCSI, SAS, Fibre Channel, or the like.

The network architecture 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, virtual tape libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

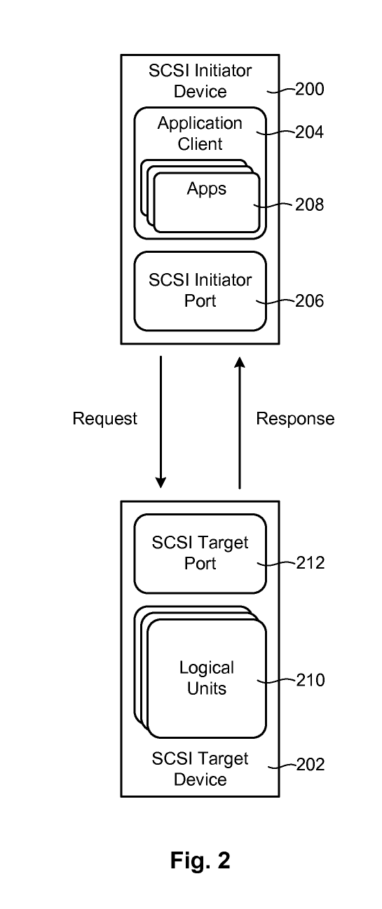

Referring to FIG. 2, in selected embodiments, the computers 102, 106 and storage systems 110, 112 described above may utilize various SCSI-based protocols, such as SCSI-over-Fibre Channel, Serial Attached SCSI (SAS), iSCSI, or the like, to transfer data and commands therebetween. In SCSI terminology, communication takes place between a SCSI initiator device 200 and a SCI target device 202. Typically, a computer 102, 106 such as a server is an initiator device 200 and a data storage device 110, 112 is a target device 202, although any of the devices 102, 106, 110, 112 can technically function as a SCSI initiator 200 and/or target 202. In operation, a SCSI initiator device 200 sends a request to the SCI target device 202 which then responds. In particular, an application client 204 in the SCSI initiator device 200 directs requests to a logical unit 210 in the SCI target device 202 by way of a SCSI initiator port 206 and a SCSI target port 212. As shown in FIG. 2, an application client 204 may have multiple applications 208 associated therewith. These applications 208 may be unrelated or may coordinate operation in some manner.

In conventional SCSI architectures, a reservation may be created between a SCSI initiator port 206 and a SCSI target port 212 to achieve exclusive access to a particular logical unit 210. When a reservation is created, an application client 204 is tied to an I_T nexus (i.e., a relationship between a single port 206 on the initiator device 200 and a single port 212 on the target device 202). Reservations in conventional SCSI architectures are limited to a single I_T nexus or a group of I_T nexuses where the group of I_T nexuses may be joined by any I_T nexus. Although a reservation established for a single I_T nexus may be effective to prevent access to a logical unit 210 by way of another I_T nexus, it does not prevent multiple applications 208 from interfering with one another over the same I_T nexus. As a result, reservations based on an I_T nexus can create data integrity problems where multiple applications 208 communicate over the same I_T nexus.

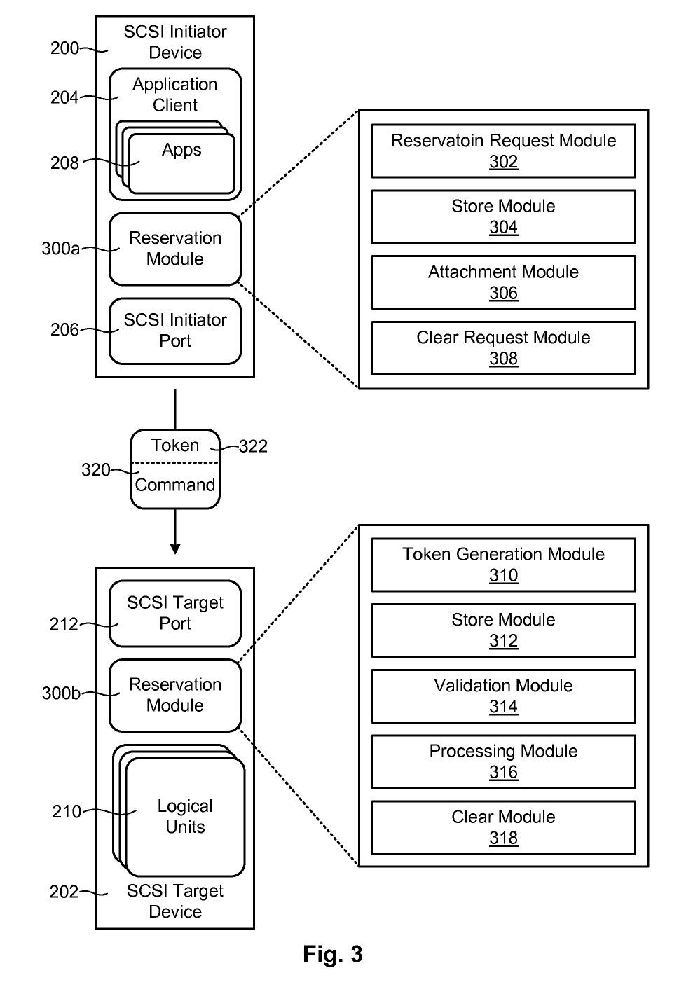

Referring to FIG. 3, in selected embodiments, a token-based reservation scheme in accordance with the invention may be used to provide more reliable reservations in SCSI architectures. FIG. 3 shows various modules that may be used to implement such a token-based reservation scheme. These modules may be implemented in hardware, software or firmware executable on hardware, or a combination thereof. These modules are presented only by way of example and are not intended to be limiting. Indeed, alternative embodiments may include more or fewer modules than those illustrated. It should also be recognized that, in some embodiments, the functionality of some modules may be broken into multiple modules or, conversely, the functionality of several modules may be combined into a single module or fewer modules. It should also be recognized that the modules are not necessarily implemented in the locations where they are illustrated. For example, some functionality shown outside an application 208 or logical unit 210 may actually be included in the application 208 or logical unit 210, and vice versa, or functionality shown in one device may actually be included in another device. Thus, the location of the modules is presented only by way of example and is not intended to be limiting.

As shown in FIG. 3, a reservation module 300a on the initiator side 200 and a reservation module 300b on the target side 202 may be provided to enable the token-based reservation scheme described herein. The reservation module 300a on the initiator side 200 may be included in an application 208 or may be a separate module that is called or invoked by an application 208. Similarly, the reservation module 300b on the target side 202 may be included in a logical unit 210 or may be a separate module that is called or invoked by a logical unit 210. In selected embodiments, the reservation module 300a on the initiator side 200 may include one or more of a reservation request module 302, a store module 304, an attachment module 306, and a clear request module 308. Similarly, the reservation module 300b on the target side 202 may include one or more of a token generation module 310, a store module 312, a validation module 314, a processing module 316, and a clear module 318.

When an application 208 needs to establish a reservation with a logical unit 210 in the SCSI target device 202, a reservation request module 302 may be used to transmit a request to the logical unit 210 for a reservation. In response, a token generation module 310 on the target side 202 generates a token for the logical unit 210. In certain embodiments, this token is generated in a substantively unique manner (e.g., pseudo-randomly) for security and/or obfuscation purposes. A store module 312 at the target 202 then stores the token, after which the token is transmitted to the application 208. Upon receiving the token at the application 208, a store module 304 stores the token so that it can be attached to future commands transmitted to the logical unit 210 while the reservation is in place. In certain embodiments, the store module 304 stores the token in a place or in a manner such that the token is not accessible to other applications 208.

When the application 208 to which the token is assigned needs to send a command 320 (e.g., a read or write command 320) to the logical unit 210 that has assigned the token, an attachment module 306 attaches the token 322 to the command 320 and transmits the command 320 to the logical unit 210. In certain embodiments, the command 320 and the token are sent in an Extended Command Descriptor Block (XCDB) with the command in the CDB field and the token in an XCDB Descriptor in accordance with the SCSI architecture. Upon receiving the command at the logical unit 210, a validation module 314 validates the token against the token stored for the logical unit 210. If the tokens match, a processing module 316 processes the command. If the tokens do not match, the command is not processed. In this way, commands originating from applications 208 or other sources that do not have the correct token 322 will be rejected. Thus, while the reservation is in place, the reservation modules 300a, 300b will prevent applications 208 that do not possess the token from interfering with an application 208 that does possess the token. This provides substantially more protection than reservations based on an I_T nexus as used in current SCSI architectures.

Once an application 208 no longer needs the reservation, a clear request module 308 may be used to request that the reservation be cleared. More specifically, the clear request module 308 transmits a request to the logical unit 210 to clear the reservation. The attachment module 306 includes the token with this request so the logical unit 210 can verify that the request originates from the application 208. Upon receiving the request, a clear module 318 at the target 202 clears the reservation, which may include retiring the token.

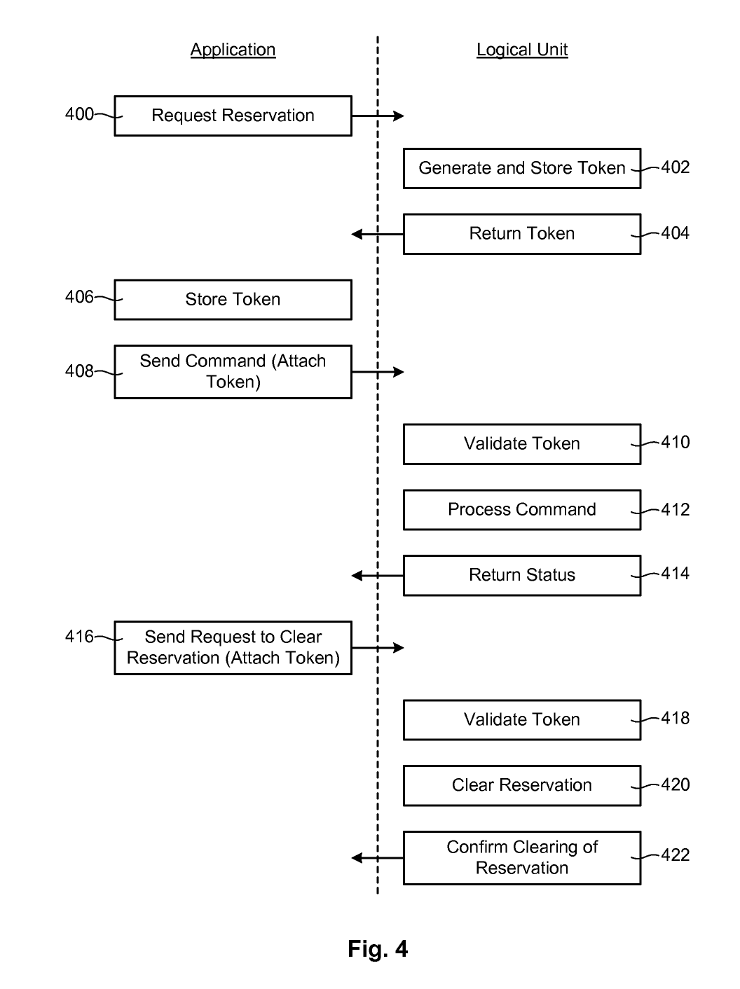

Referring to FIG. 4, a flow diagram showing exemplary communication between an application 208 and a logical unit 210 when using a token-based reservation scheme is illustrated. As shown, the application 208 initially transmits 400 a request for a reservation to a logical unit 210. In response, the logical unit 210 generates 402 and stores 402 a token, and returns 404 the token to the application 208. At this point, the token may be considered “checked out.” Once a token is checked out, other applications 208 may be prevented from checking out tokens until this token is checked back in (as shown in step 416). Thus, in this embodiment, only one token is checked out at any particular time. Upon receiving the token, the application 208 stores 406 the token so that it can be attached to commands transmitted while the reservation is in place. Storing the token 406 may include storing the token in a place or in a manner such that the token is not accessible to other applications 208.

To access data on the logical unit 210 while the reservation is in place, the application 208 sends 408 a command 320 (e.g., a read or write command) to the logical unit 210 with the token 322 attached. Upon receiving the command 320, the logical unit 210 validates 410 the token 322 by comparing the attached token with the stored token. In this particular example, the tokens are determined to match at step 410. Since a match is found, the logical unit 210 processes 412 the command 320. The logical unit 210 then returns 414 a status message indicating that the command 320 completed successfully.

When the application 208 no longer needs the reservation, the application 208 sends 416 a request to the logical unit 210 to clear the reservation. The token is attached to this request to confirm that the application 208 is the originator of the request. Upon receiving the request, the logical unit 210 validates 418 the token and clears the reservation, which may include retiring the token. The logical unit 210 then sends 422 confirmation to the application 208 that the reservation is cleared. At this point, since the token is checked in, the same or another application 208 may send a request 400 to the logical unit 210 to create a new reservation, including a new token.

The token-based reservation scheme described in FIGS. 3 and 4 substantially improves the reliability of reservations between applications 208 and logical units 210. This can provide several advantages compared to conventional I_T nexus-based reservations. For example, the token-based reservation scheme protects data accessed by one application 208 operating on a server from being accessed by other applications 208 operating on the same server while the reservation is in place. Also, the token-based reservation scheme may provide significantly more effective reservations for distributed applications, i.e., those distributed across multiple servers or devices. Once the token is obtained from a particular logical unit 210, a distributed application 208 may communicate with the logical unit 210 from any server or device, regardless of the ports or communication paths used, as long as the distributed application 208 uses the correct token.

The token-based reservation scheme may also enable several applications 208 to work together in a more effective manner. For example, once a first application 208 has finished accessing data on a logical unit 210, the application 208 may pass its token to another application 208 to access the same or different data on the logical unit 210. In other embodiments, several applications 208 may possess the token at the same time, and thus have access to data on the same logical unit 210 at the same time, as long as the applications are coordinated in their action and do not compromise data integrity. Once the applications 208 are finished accessing the data, either application 208 may clear the reservation by sending the appropriate request with the token attached thereto. In this way, several applications 208, whether on the same or different servers or devices, may coordinate their operation using the token-based reservation scheme.

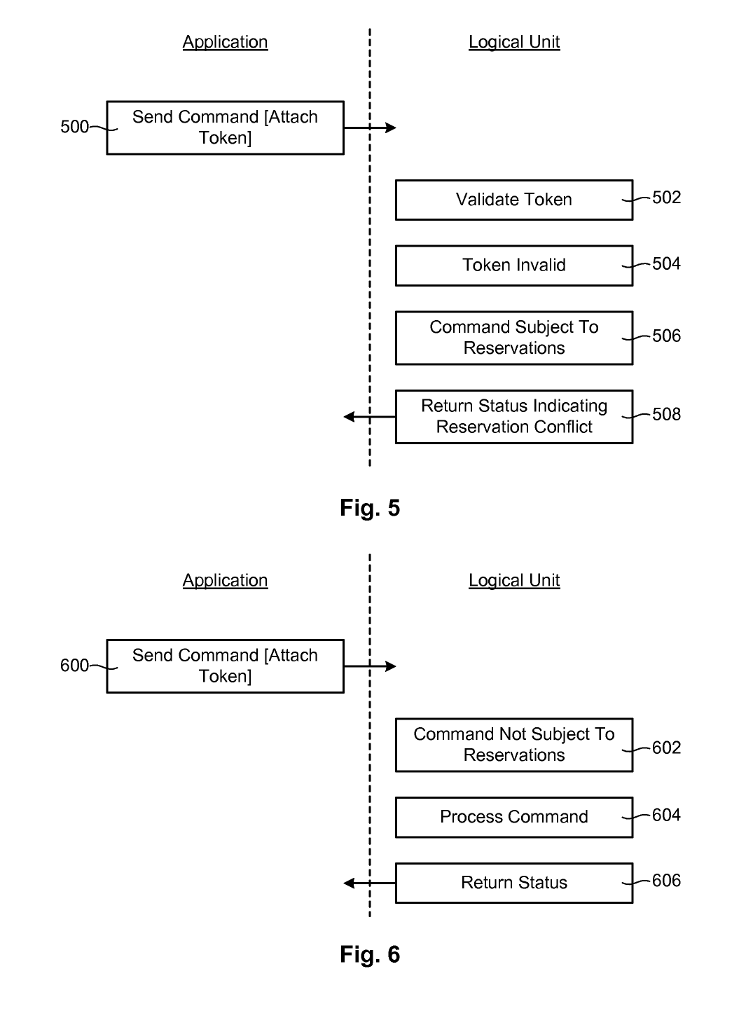

Referring to FIG. 5, a flow diagram showing exemplary communication between an application 208 and a logical unit 210 when a token is not valid is illustrated. In this example, an application 208 sends 500 a command 320 to a logical unit 210 with a token 322 attached. Upon receiving the command 320, the logical unit 210 attempts to validate 502 the token by comparing the attached token with a stored token (assuming a token has been checked out to an application). In this example, the tokens are determined to not match at step 504. The command is also determined to be subject to reservations at step 506, meaning that the command will be rejected if a reservation is in place and the command is not accompanied by the correct token. Because the tokens do not match, the logical unit 210 refuses to process the command 320. The logical unit 210 then returns 508 a status message indicating that the command 320 was not processed due to a reservation conflict.

Referring to FIG. 6, a flow diagram showing exemplary communication between an application 208 and a logical unit 210 for a command that is not subject to reservations is illustrated. In this example, an application 208 sends 600 a command 320 to a logical unit 210 with or without a token 322 attached. Upon receiving the command 320, the logical unit 210 determines at step 602 that the command is not subject to reservations. This means that the command may be processed regardless of whether a reservation is in place and regardless of whether the command includes the correct token. Such commands may include those that request the identity of the SCSI target device 202 or logical unit 210 or perform some other operation that is known not to compromise data integrity. Upon making such a determination 602, the logical unit 210 processes 604 the command. The logical unit 210 then returns 606 a status message indicating that the command completed successfully. Despite processing 604 the command, the reservation will remain in place such that subsequent commands 320 will continue to be evaluated as to whether they include the correct token, and thus are or are not authorized to be processed during the reservation, or whether the commands are not subject to reservations.

In selected embodiments, an override command may be provided to override a reservation, if needed. For example, if a server or application 208 on a server freezes up or fails, or if a server or application 208 is rendered inoperable for some other reason, an override command may be established to clear the reservation and the associated token so that the logical unit 210 does not become unusable. If such an override is necessary, notification may be sent, if possible, to the application 208 previously holding the reservation so the application 208 is aware that the reservation was terminated.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for enabling reservations in SCSI architectures, the method comprising:
receiving a reservation request from a SCSI initiator;
generating a token in response to receiving the reservation request;
storing the token and transmitting a copy of the token to the SCSI initiator;
receiving a command from the SCSI initiator, the command having a token attached thereto;
comparing the attached token to the stored token; and
processing the command if the attached token matches the stored token.

2. The method of claim 1, further comprising not processing the command if the attached token fails to match the stored token.

3. The method of claim 2, further comprising returning status indicating a reservation conflict if the attached token fails to match the stored token.

4. The method of claim 1, wherein generating the token comprises generating a substantially unique token.

5. The method of claim 1, further comprising receiving a request to clear the reservation.

6. The method of claim 5, further comprising retiring the token in response to receiving the request to clear the reservation.

7. The method of claim 1, further comprising processing the command if the command is not subject to reservations.

8. A system for enabling reservations in SCSI architectures, the system comprising:
a SCSI initiator to send a reservation request;
a SCSI target to receive the reservation request, generate and store a token in response to receiving the reservation request, and transmit a copy of the token to the SCSI initiator;
the SCSI initiator further configured to transmit a command to the SCSI target, the command having a token attached thereto; and
the SCSI target configured to receive the command, compare the attached token to the stored token, and process the command if the attached token matches the stored token.

9. The system of claim 8, wherein the SCSI target is further configured to not process the command if the attached token fails to match the stored token.

10. The system of claim 9, wherein the SCSI target is further configured to return status indicating a reservation conflict if the attached token fails to match the stored token.

11. The system of claim 8, wherein the SCSI target is configured to generate the token to be substantially unique.

12. The system of claim 8, wherein the SCSI initiator is further configured to transmit a request to clear the reservation.

13. The system of claim 12, wherein the SCSI target is further configured to retire the token in response to receiving the request to clear the reservation.

14. The system of claim 8, wherein the SCSI target is further configured to process the command if the command is not subject to reservations.

15. A computer program product to enable reservations in SCSI architectures, the computer program product comprising a computer-usable storage medium having computer-usable program code embodied therein, the computer-usable program code comprising:
computer-usable program code to receive a reservation request from a SCSI initiator;
computer-usable program code to generate a token in response to receiving the reservation request;
computer-usable program code to store the token and transmit a copy of the token to the SCSI initiator;
computer-usable program code to receive a command from the SCSI initiator, the command having a token attached thereto;
computer-usable program code to compare the attached token to the stored token; and
computer-usable program code to process the command if the attached token matches the stored token.

16. The computer program product of claim 15, further comprising computer-usable program code to not process the command if the attached token fails to match the stored token.

17. The computer program product of claim 16, further comprising computer-usable program code to return status indicating a reservation conflict if the attached token fails to match the stored token.

18. The computer program product of claim 15, wherein generating the token comprises generating a substantially unique token.

19. The computer program product of claim 15, further comprising computer-usable program code to receive a request to clear the reservation from the SCSI initiator.

20. The computer program product of claim 19, further comprising computer-usable program code to retire the token in response to receiving the request to clear the reservation.
